(19) United States
(12) Patent Application Publication
(10) Pub. No.: US 2023/0302795 A1
(43) Pub. Date: Sep. 28, 2023

(54) LIQUID EJECTION HEAD

(71) Applicant: TOSHIBA TEC KABUSHIKI KAISHA, Tokyo (JP)

(72) Inventor: Masashi SHIMOSATO, Mishima Shizuoka (JP)

(21) Appl. No.: 18/075,369

(22) Filed: Dec. 5, 2022

(30) Foreign Application Priority Data
Mar. 28, 2022 (JP) 2022-052159

(51) Int. Cl. B41J 2/14

(52) U.S. Cl. CPC B41J 2/14201; B41J 2002/14306

(57) ABSTRACT

A liquid ejection head for ejecting a liquid, includes a base plate extending along a first direction, an actuator unit on the plate and including first piezoelectric elements and one or more support elements arranged along the first direction, a flow path member on the actuator unit and including: pressure chambers each for storing the liquid and having volumes that can be changed by a corresponding one of the first piezoelectric elements, and one or more first openings at positions corresponding to the support elements, and a nozzle plate on the flow path member and including: nozzles through which the liquid in the corresponding pressure chambers are ejected in response to a change in the volume of the corresponding pressure chambers, and one or more second openings connected respectively to the first openings and through which the support elements corresponding to the first openings are visible.

### CROSS-REFERENCE TO RELATED APPLICATION(S)

This application is based upon and claims the benefit of priority from Japanese Patent Application No. 2022-052159, filed Mar. 28, 2022, the entire contents of which are incorporated herein by reference.

### FIELD

Embodiments described herein relate generally to a liquid ejection head.

### BACKGROUND

A certain type of liquid ejection head such as an ink jet head has a diaphragm deformed by an actuator having a piezoelectric body such as a PZT to apply pressure to a pressure chamber facing the diaphragm and eject ink from a nozzle communicating with the pressure chamber. For example, such a liquid ejection head includes an actuator member having a plurality of drive elements and a flow path member forming a plurality of pressure chambers and a predetermined flow path.

For example, in the actuator, a groove is formed in a piezoelectric member, and a plurality of piezoelectric elements are formed in parallel. Then, by applying a voltage to a piezoelectric element to be driven, vibration is applied to the ink in the pressure chamber facing the piezoelectric element, and ink droplets are ejected from the nozzle communicating with the pressure chamber.

### SUMMARY OF THE INVENTION

Embodiments provide a liquid ejection head capable of securing positional accuracy between a plurality of pressure chambers and a plurality of piezoelectric elements.

In one embodiment, a liquid ejection head for ejecting a liquid, includes a base plate extending along a first direction, an actuator unit on the base plate and including a plurality of first piezoelectric elements and one or more support elements arranged along the first direction, a flow path member on the actuator unit and including: a plurality of pressure chambers each for storing the liquid and having volumes that can be changed by a corresponding one of the first piezoelectric elements, and one or more first openings at positions corresponding to the support elements, and a nozzle plate on the flow path member and including: a plurality of nozzles through which the liquid in the corresponding pressure chambers are ejected in response to a change in the volume of the corresponding pressure chambers, and one or more second openings connected respectively to the one or more first openings and through which the support elements corresponding to the one or more first openings are visible.

### BRIEF DESCRIPTION OF THE DRAWINGS

FIG. 1 is a plan view of an inkjet head according to a first embodiment.

FIGS. 2 and 3 are cross-sectional views of the inkjet head.

FIG. 4 is a schematic diagram of an inkjet recording apparatus according to the first embodiment.

FIGS. 5 and 6 are plan views of an inkjet head according to another embodiment.

FIG. 7 depicts a flow path window portion of an inkjet head according to another embodiment.

### DETAILED DESCRIPTION

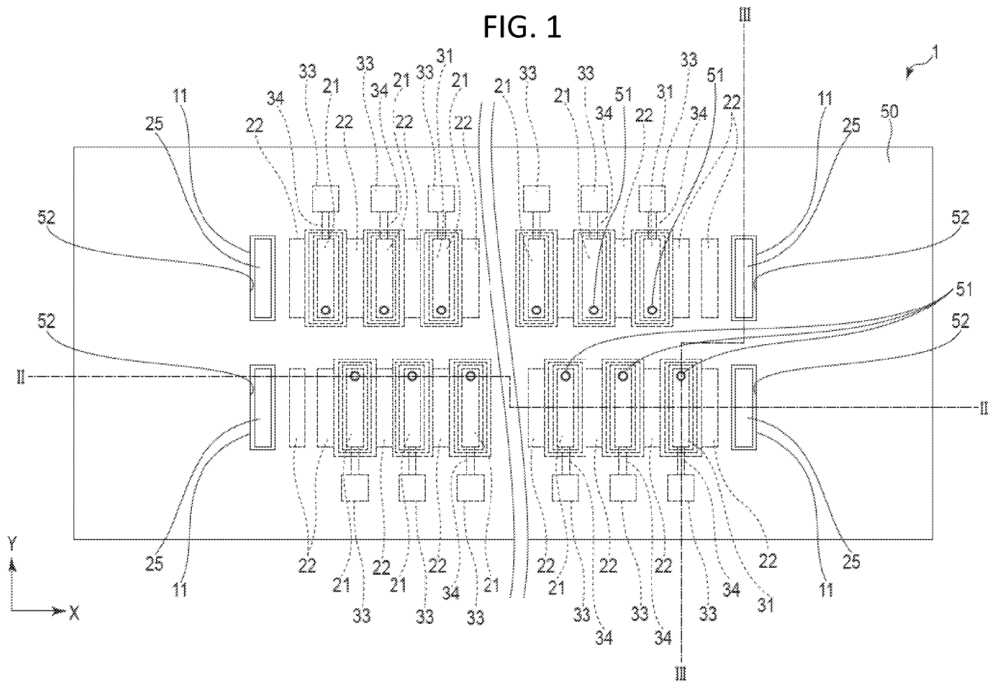

Hereinafter, an inkjet head 1 which is an example of a liquid ejection head and an inkjet recording apparatus 100 which is an example of a liquid ejection apparatus according to a first embodiment will be described with reference to FIGS. 1 to 4.

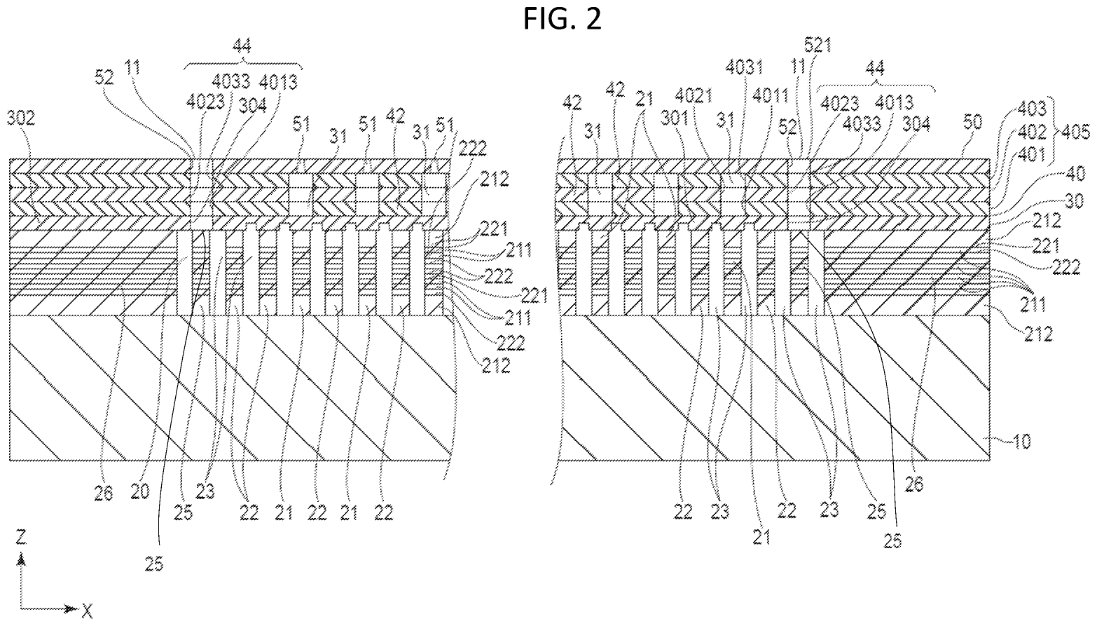

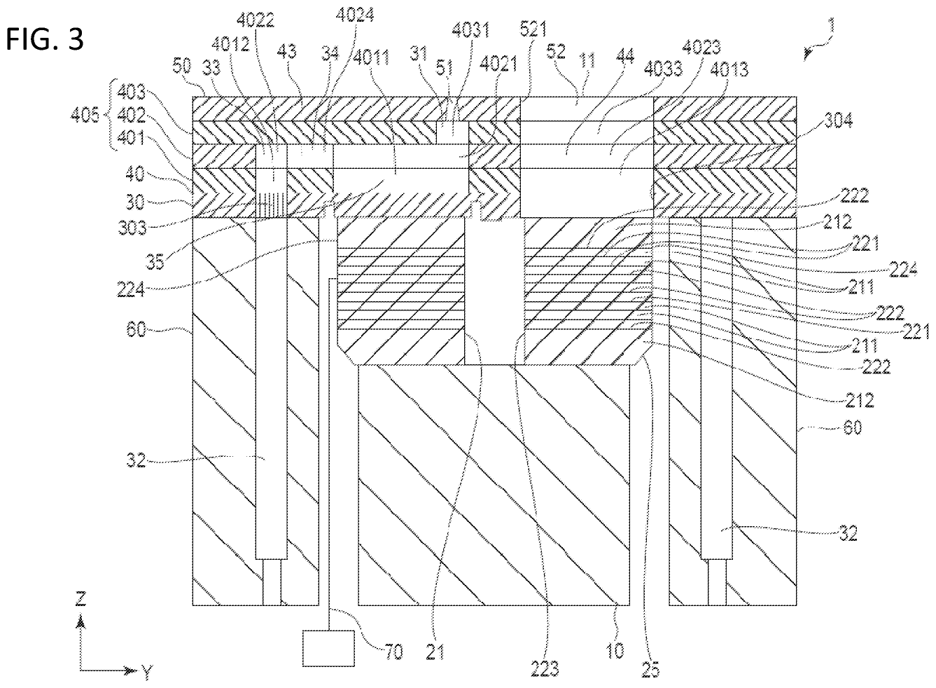

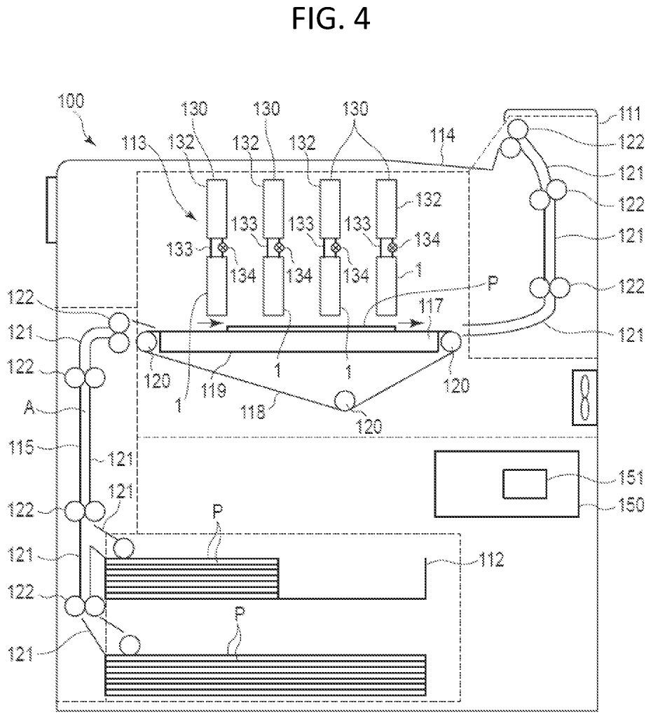

FIG. 1 is a plan view of the inkjet head 1, and FIGS. 2 and 3 are cross-sectional views of the inkjet head 1. FIG. 4 is a schematic diagram of the inkjet recording apparatus 100. Arrows X, Y, and Z in the drawings indicate three directions orthogonal to each other. For the purpose of explanation in the drawings, one or more elements are appropriately enlarged, reduced, or omitted.

As illustrated in FIGS. 1 to 3, the inkjet head 1 includes a base 10, a plurality of actuator units 20, a flow path member 40, a nozzle plate 50 having a plurality of nozzles 51, a frame portion 60, and a drive circuit 70. As an example, the inkjet head 1 includes two actuator units 20, and includes two nozzle rows in which the nozzles 51 are arranged in the column direction (i.e., X direction), two pressure chamber rows in which a plurality of pressure chambers 31 are arranged in the column direction, and two element rows in which the piezoelectric elements 21 and 22 and support elements 25 are arranged in the column direction.

The base 10 is formed in a rectangular plate shape, for example.

The actuator units 20 are arranged on one surface of the base 10 in the stacking direction. For example, the actuator units 20 are provided in two rows in parallel on the base 10.

Each actuator unit 20 includes, for example, a plurality of driving piezoelectric elements 21 and a plurality of non-driving piezoelectric elements 22 which are alternately arranged along the column direction, support elements 25 which are arranged at both end portions of the row of the piezoelectric elements 21 and 22, and piezoelectric structure portions 26 which are arranged outside the column elements 25 in the column direction.

In each actuator unit 20, the driving piezoelectric elements 21, the non-driving piezoelectric elements 22, and the support elements 25 at both ends are arranged in one direction at regular intervals.

For example, each of the driving piezoelectric elements 21, the non-driving piezoelectric elements 22, and the support elements 25 at both ends is formed into a rectangular parallel-piped columnar shape having the same outer shape. Each actuator unit 20 is divided into a plurality of grooves 23, and the driving piezoelectric elements 21, the non-driving piezoelectric elements 22, and the support elements 25 are all arranged in the column direction at the same pitch by the grooves 23 having the same width.

The piezoelectric elements 21 and 22 and the support elements 25 may be separated from each other by the grooves 23, and may be integrally connected to each other on the base 10 side. For example, this structure can be formed by forming the grooves 23 from one side in the stacking direction of the piezoelectric member having the depth shorter than the total length in the stacking direction of the laminated piezoelectric member.

For example, the driving piezoelectric elements 21, the non-driving piezoelectric elements 22, and the support elements 25 at both ends are formed in a rectangular shape in which the lateral direction is along the column direction (i.e., X direction) of the element column and the longitudinal direction is along the extending direction (i.e., Y direction) orthogonal to the column direction and the stacking direction in a plan view viewed from the stacking direction.

The driving piezoelectric elements 21 are arranged at positions corresponding to the pressure chambers 31 formed in the flow path member 40 in the stacking direction. For example, the center positions in the column direction and the extension direction of the driving piezoelectric element 21 and the center positions in the column direction and the extension direction of the pressure chamber 31 are arranged side by side in the stacking direction.

The non-driving piezoelectric elements 22 are arranged at positions corresponding to a plurality of partition wall portions 42 formed in the flow path member 40 in the stacking direction. For example, the center positions in the column direction and the extension direction of the driving piezoelectric element 21 and the center positions in the column direction and the extension direction of the partition wall portion 42 are arranged side by side in the stacking direction.

The support element 25 is arranged at a position corresponding to a flow path window portion 44 formed in the flow path member 40 and a nozzle window portion 52 formed in the nozzle plate 50 in the stacking direction. For example, the center positions in the column direction and the extension direction of the support element 25 and the center positions in the column direction and the extension direction of the nozzle window portion 52 and the flow path window portion 44 are arranged side by side in the stacking direction.

For example, another non-driving piezoelectric element 22 may be disposed between the non-driving piezoelectric element 22 disposed at the end portion of the row and the support element 25 according to the arrangement of the nozzles 51 as shown in FIGS. 1 and 2. In this example, at a first end portion of one element row and a second end portion of the other element row, two non-driving piezoelectric elements 22 are disposed between the piezoelectric element 21 disposed at the end portion and the support element 25, and at the second end portion of said one element row and the first end portion of the other element row, one non-driving piezoelectric element 22 is disposed between the piezoelectric element 21 disposed at the end portion and the support element 25. Further, the support elements 25 formed at both ends of the two rows are arranged side by side in the extending direction.

The piezoelectric structure portions 26 are disposed on the outer side in the column direction of the element row in which the driving piezoelectric elements 21, the non-driving piezoelectric elements 22, and the support elements are arranged. The piezoelectric structure portion 26 has the same stacked structure as the piezoelectric elements 21 and 22 and the support elements 25 forming the element array, and is sandwiched between a manifold 405 and the base 10.

For example, the actuator unit 20 includes a plurality of piezoelectric elements formed in a rectangular columnar shape at predetermined intervals by dicing a stacked piezoelectric member bonded to the base 10 in advance to form a plurality of grooves 23. Then, electrodes and the like are provided in the columnar elements formed, and a plurality of driving piezoelectric elements 21 and a plurality of non-driving piezoelectric elements 22 arranged alternately, and a support element 25 arranged at an end portion in the arrangement direction are formed. The driving piezoelectric elements 21 and the non-driving piezoelectric elements 22 are alternately arranged in parallel with the grooves 23 interposed therebetween in the column direction, and the support elements 25 are further arranged at either or both ends of the piezoelectric elements 21 and 22 in the column direction with the grooves 23 interposed therebetween.

For example, the stacked piezoelectric member forming the actuator unit 20 is formed by stacking and sintering a sheet-shaped piezoelectric material.

The piezoelectric member including the driving piezoelectric elements 21, the non-driving piezoelectric elements 22, and the support elements 25 is, for example, a stacked piezoelectric body. The driving piezoelectric elements 21, the non-driving piezoelectric elements 22, and the support elements 25 include a plurality of stacked piezoelectric layers 211 and internal electrodes 221 and 222 formed on the surfaces of the piezoelectric layers 211. For example, the driving piezoelectric elements 21, the non-driving piezoelectric elements 22, and the support elements have the same stacked structure. The driving piezoelectric elements 21 and the non-driving piezoelectric elements 22 include external electrodes 223 and 224 formed on their surfaces.

The piezoelectric layers 211 are formed in a thin plate shape from a piezoelectric material such as PZT (lead zirconate titanate) or lead-free KNN (sodium potassium niobate). The piezoelectric layers 211 are stacked in the thickness direction along the stacking direction and bonded to each other.

The internal electrodes 221 and 222 are conductive films formed of a calcinable conductive material such as silver-palladium in a predetermined shape. The internal electrodes 221 and 222 are formed in a predetermined region of the surface of each piezoelectric layer 211. The internal electrodes 221 and 222 have poles different from each other. For example, one internal electrode 221 is formed in a region that reaches one end portion of the piezoelectric layer 211 and does not reach the other end portion of the piezoelectric layer 211 in the extension direction (i.e., Y direction) orthogonal to both of the column direction (i.e., X direction) and the stacking direction (i.e., Z direction) of the piezoelectric layer 211, which is an arrangement direction of the driving piezoelectric elements 21 and the non-driving piezoelectric elements 22. The other internal electrode 222 is formed in a region not reaching one end of the piezoelectric layer 211 but reaching the other end of the piezoelectric layer 211 in the extending direction. The internal electrodes 221 and 222 are connected to external electrodes 223 and 224 formed on side surfaces of the piezoelectric elements 21 and 22, respectively.

Further, the stacked piezoelectric member including the driving piezoelectric elements 21, the non-driving piezoelectric elements 22, and the support elements 25 further includes a dummy layer 212 at either or both of the end portions of the base 10 side and the nozzle plate 50 side in the stacking direction. The dummy layer 212 is made of, for example, the same material as that of the piezoelectric layer 211, has an electrode only on one side, and is not deformed because an electric field is not applied thereto. For example, the dummy layer 212 does not function as a piezoelectric body, and serves as a base for fixing the actuator unit 20 to the base 10, or serves as a polishing margin for polishing in order to obtain accuracy during assembly or after assembly.

The external electrodes 223 and 224 are formed on the surfaces of the driving piezoelectric elements 21 and the non-driving piezoelectric elements 22. For example, the external electrodes 223 and 224 are respectively formed on one end face and the other end face in the extending direction of the piezoelectric layer 211. The external electrodes 223 and 224 are formed by Ni, Cr, Au or the like by a known method such as a plating method or a sputtering method. The external electrode 223 and the external electrode 224 have different poles. The external electrode 223 and the external electrode 224 are disposed on different side surfaces of the driving piezoelectric elements 21 and the non-driving piezoelectric elements 22, respectively. Note that the external electrodes 223 and 224 may be routed to different regions among the same side surface portions of the driving piezoelectric elements 21 and the non-driving piezoelectric elements 22.

In the present embodiment, the external electrode 223 is an individual electrode, and the external electrode 224 is a common electrode. A plurality of external electrodes 223 serving as individual electrodes of the driving piezoelectric elements 21 and the non-driving piezoelectric elements 22 are divided into electrode layers by the grooves 23, and are arranged independently of each other. In the external electrode 224 serving as a common electrode, the electrode layers are connected to each other, and are grounded, for example. The external electrodes 223 and 224 are connected to the drive circuit 70 via, for example, a wiring film. For example, each of the external electrodes 223 and 224 is connected to a control unit 150 as a drive unit via a driver of the drive circuit 70 by the wiring film, and is capable of being driven and controlled by the control of a processor 151. The arrangement of the common electrode and the individual electrode may be reversed.

For example, in each of the piezoelectric elements 21 and 22 and the support elements 25, the number of stacked piezoelectric layers 211 is set to 50 or less, the thickness of each layer is set to 10 μm to 40 μm, and the product of the thickness and the total number of stacked layers is set to less than 1000 μm. Further, in the present embodiment, the printing resolution is set to be equal to or higher than 600 dpi (dots per inch), and the pitch of the driving piezoelectric elements 21 and 22 are set to be equal to or higher than 300 dpi. That is, the pitch of the element rows of the driving piezoelectric elements 21 and the non-driving piezoelectric elements 22 is about 85 μm or less, and for example, when about 30 μm is secured in the groove width of one groove 23, the width of each piezoelectric element is 55 μm or less.

The driving piezoelectric element 21 longitudinally vibrates along the stacking direction of the piezoelectric layer 211 when a voltage is applied to the internal electrodes 221 and 222 via the external electrodes 223 and 224. The term “longitudinal vibration” as used herein refers to, for example, “vibration in the thickness direction defined by the piezoelectric constant d33”. The driving piezoelectric element 21 displaces the diaphragm 30 by longitudinal vibration to deform the pressure chamber 31.

The flow path member 40 includes the diaphragm 30 disposed along one side of the actuator unit 20 in the stacking direction, and the manifold 405 stacked on the diaphragm 30.

The diaphragm 30 is provided between the manifold 405 and the actuator unit 20 in the stacking direction. The diaphragm 30 forms the flow path member 40 together with the manifold 405.

The diaphragm 30 extends along a plane orthogonal to the stacking direction, and is bonded to one side of the piezoelectric layer 211 of the driving piezoelectric elements 21 and 22 in the stacking direction, that is, a surface on the nozzle plate 50 side. The diaphragm 30 is deformable, for example. The diaphragm 30 is joined to the driving piezoelectric elements 21 and the non-driving piezoelectric elements 22 of the actuator unit 20 and the frame portion 60. For example, the diaphragm 30 has a vibration region 301 facing the piezoelectric elements 21 and 22, and a support region 302 facing the frame portion 60.

The vibration region 301 has, for example, a flat plate shape arranged such that the thickness direction is the stacking direction of the piezoelectric layer 211. The diaphragm 30 extends in the plane direction in the arrangement direction of the driving piezoelectric elements 21 and the non-driving piezoelectric elements 22. The diaphragm 30 is, for example, a metal plate. The diaphragm has a plurality of vibration portions that face the respective pressure chambers 31 and can be individually displaced. The diaphragm 30 is formed by integrally connecting a plurality of vibration portions.

For example, the diaphragm 30 is formed of a SUS plate, and the thickness dimension along the stacking direction is about 5 μm to 15 μm. In the vibration region 301, a folding line or a step may be formed in a portion adjacent to the vibration portion or between the vibration portions adjacent to each other so that the vibration portions are easily displaced. The vibration region 301 is deformed by displacement of a portion disposed opposite to the driving piezoelectric element 21 due to expansion and compression of the driving piezoelectric element 21. For example, the diaphragm 30 is formed by an electroforming method or the like because it requires a very thin and complicated shape. The diaphragm 30 is bonded to the upper end surface of the actuator unit 20 by bonding or the like.

The support region 302 is a plate-like member disposed between the frame portion 60 and the manifold 405. The support region 302 includes a communication portion 303 having a through-hole communicating with a common chamber 32, and an opening portion 304 having a through-hole and forming a part of the flow path window portion 44.

For example, the communication portion 303 includes a filter member having a plurality of pores through which liquid can pass.

The opening portion 304 is disposed so as to overlap with third openings 4013, 4023, and 4033 of other flow path substrates 401, 402, and 403, thereby forming the flow path window portion 44. The opening portion 304 is formed at a position corresponding to the support element 25 and the nozzle window portion 52 in the stacking direction. For example, the opening portion 304 is a through-hole through which a region including an end face of the support element 25 is opened. For example, the opening portion 304 is disposed at at least each of two positions opposed to each other in the column direction and the extension direction. As an example, in the present embodiment, the two vibration regions 301 are formed at four positions that are both ends in the column direction. Note that the opening portions 304 may have the same shape or different shapes.

The manifold 405 is disposed between the nozzle plate 50 and the diaphragm 30 in the stacking direction. The manifold is joined to one side of the diaphragm 30 in the stacking direction.

The manifold 405 includes the flow path substrates 401, 402, and 403 that are stacked. As an example, the manifold 405 includes the first flow path substrate 401, the second flow path substrate 402, and the third flow path substrate 403 in a stacked manner.

The manifold 405 is disposed between the nozzle plate 50 and the diaphragm 30. The manifold 405 includes the flow path substrates 401, 402, and 403 stacked and joined to each other, thereby forming a predetermined ink flow path 35 having a plurality of pressure chambers 31, a common flow path 33 communicating with the common chamber 32, and a plurality of individual flow paths 34 extending from the common flow path 33 to the pressure chamber 31. In other words, the manifold 405 includes, by the flow path substrates 401, 402, and 403 to be stacked, a peripheral wall portion 41 surrounding the ink flow path 35 (i.e., the liquid chamber) formed by the pressure chambers 31, the individual flow paths 34, and the common flow path 33, a partition wall portion 42 as a plurality of flow path support columns separating the pressure chambers 31, and a side wall portion 43 separating the individual flow paths 34. Further, in the manifold 405, the third openings 4013, 4023, and 4033 of the flow path substrates 401, 402, and 403 to be stacked are continuous, so that a part of the flow path window portion 44 is formed. In the manifold 405, the ink flow path 35 and the flow path window portion 44 are separated from each other.

The first flow path substrate 401 is bonded to the diaphragm 30. The first flow path substrate 401 is a plate-like member having the same shape as the diaphragm 30, and has a first opening 4011 forming a part of the pressure chamber 31, a second opening 4012 forming a part of the common flow path 33, and a plurality of third openings 4013 forming a part of the flow path window portion 44.

The second flow path substrate 402 is bonded to the first flow path substrate 401. The second flow path substrate 402 is a plate-shaped member having the same shape as that of the diaphragm 30, and has a first opening 4021 that forms a part of the pressure chamber 31, a second opening 4022 that forms a part of the common flow path 33, a plurality of third openings 4023 that form a part of the flow path window portions 44, and a communication groove 4024 that communicates the first opening 4021 and the second opening 4022 and forms the individual flow path 34. The second flow path substrate 402 has a side wall portion 43 which is a wall member forming the individual flow path 34.

The third flow path substrate 403 is bonded to the second flow path substrate 402. The third flow path substrate 403 is a plate-shaped member having the same outer shape as the diaphragm 30, and has a first opening 4031 forming a part of the pressure chamber 31 and a plurality of third openings 4033 forming a part of the flow path window portions 44.

The pressure chambers 31 are spaces formed on one side of the vibration region 301 of the diaphragm 30, and are formed by the first openings 4011, 4021, and 4031 of the flow path substrates 401, 402, and 403 arranged in the stacking direction. Each pressure chamber 31 communicates with a nozzle 51 formed in the nozzle plate 50. The pressure chamber 31 is closed on the opposite side of the nozzle plate 50 by the diaphragm 30.

The pressure chambers 31 communicate with the common chamber 32 via the communication portion 303 via the individual flow path 34 and the common flow path 33. The pressure chamber 31 holds the liquid supplied from the common chamber 32 and is deformed by the vibration of the diaphragm 30 forming a part of the pressure chamber 31, thereby discharging the liquid from the nozzle 51.

The partition wall portion 42 is a wall-shaped member that separates the pressure chambers 31 in the arrangement direction. The partition wall portion 42 is disposed to face the non-driving piezoelectric element 22 via the diaphragm 30, and is supported by the non-driving piezoelectric element 22. A plurality of partition wall portions 42 is provided at the same pitch as the pitch at which the pressure chambers 31 are arranged.

The side wall portion 43 is a wall-shaped member that separates the individual flow channels 34 in the column direction. For example, the side wall portion 43 is provided at the inlet of the pressure chamber 31. The side wall portion 43 is configured such that the flow path resistance of the individual flow path 34 is larger than the inside of the pressure chamber 31, and the flow path cross-sectional area of the individual flow path 34 is smaller than the inside of the pressure chamber 31. A plurality of side wall portions 43 is provided at the same pitch as the pitch at which the pressure chambers 31 are arranged.

The flow path window portion 44 is a through hole including the third openings 4013, 4023, and 4033 of the flow path substrates 401, 402, and 403 and the opening portion 304 formed in the diaphragm 30, that are continuously formed in the stacking direction. The flow path window portion 44 is a part of an observation window 11 for optically detecting the position of the support element 25. The flow path window portion 44 is separated from the ink flow path 35 of the flow path member 40.

For example, the flow path window portion 44 is disposed at at least each of two positions opposed to each other in the column direction and the extending direction. As an example, in the present embodiment, the flow path window portion 44 is disposed at each of four positions corresponding to both ends of the two rows. Note that those flow path window portions 44 may have the same structure or different structures.

The nozzle plate 50 is formed in a rectangular plate shape having a thickness of about 10 μm to 100 μm, which is made of, for example, a metallic material such as SUS·Ni or a resinous material such as polyimide. The nozzle plate 50 is disposed on one side of the manifold 405 so as to cover an opening on one side of the pressure chamber 31. In the nozzle plate 50, the nozzles 51 penetrating in the thickness direction and nozzle window portions 52 each constituting a part of the observation window 11 are formed.

The nozzles 51 are arranged in the same first direction as the arrangement direction of the pressure chambers 31 to form a nozzle row. For example, the nozzles 51 are provided in two rows, and the nozzles 51 are provided at positions corresponding to the pressure chambers 31 arranged in two rows. In the present embodiment, each of the nozzles 51 is provided at an end portion of the pressure chamber 31 in the extending direction. For example, the nozzles 51 in one row and the nozzles 51 in the other row are alternately arranged in a staggered manner.

The nozzle window portion 52 is a light transmitting portion that transmits light. For example, the nozzle window portion 52 has an opening 521 that penetrates the nozzle plate 50 in the thickness direction. The nozzle window portion 52 is provided at both end portions in the column direction of the nozzle row in which the nozzles 51 are arranged. For example, the nozzle window portion 52 is disposed at at least each of two positions opposed to each other in the column direction and the extension direction. In the present embodiment, the nozzle window portion 52 is disposed at each of four positions corresponding to both ends of each row. Note that the nozzle window portions 52 may have the same shape or different shapes.

For example, the flow path window portion 44 and the nozzle window portion 52 that make up the observation window 11 have the same shape when viewed from the stacking direction. The outline of the observation window 11, that is, the outline of the flow path window portion 44 and the nozzle window portion 52 includes a region facing the entire circumference of an edge 251 of the end face of the support element 25, and is formed in a rectangular shape having the same shape as the end face shape. As an example, in order to ensure visibility, the outer shape of the observation window 11 is preferably larger than the shape of the edge of the support element 25 by about 5 to 30 μm per side.

The frame portion 60 is a structure joined to the diaphragm 30 together with the piezoelectric elements 21 and 22. The frame portion 60 is provided on the side of the piezoelectric elements 21 and 22 opposite to the manifold 405 of the diaphragm 30, and is disposed adjacent to the actuator unit 20 in the present embodiment, for example. The frame portion 60 is an outer frame of the inkjet head 1. The frame portion 60 may have a liquid flow path formed therein. In the present embodiment, the frame portion 60 is joined to the other side of the diaphragm 30 and forms the common chamber 32 with the diaphragm 30.

The common chamber 32 is formed inside the frame portion 60 and communicates with each pressure chamber 31 through the communication portion 303 provided in the diaphragm 30, the common flow path 33, and the individual flow path 34.

The drive circuit 70 includes a wiring film having one end connected to the external electrodes 223 and 224, a driver IC mounted on the wiring film, and a printed wiring board mounted on the other end of the wiring film.

The drive circuit 70 drives the driving piezoelectric elements 21 by applying a driving voltage to the external electrodes 223 and 224 by the driver IC, thereby increasing or decreasing the volume of the pressure chambers 31 and discharging droplets from the nozzles 51.

The wiring film is connected to the external electrodes 223 and 224. For example, the wiring film is an ACF (Anisotropic Conductive Film) fixed to the connecting portions of the external electrodes 223 and 224 by thermocompression bonding or the like. The wiring films are, for example, COF (Chip on Film) on which a driver IC is mounted.

The driver IC is connected to the external electrodes 223 and 224 via the wiring film. The driver IC may be connected to the external electrodes 223 and 224 by other means such as ACP (Anisotropic Conductive Paste), NCF (non-conductive film), and NCP (Non-Conductive Paste) instead of the wiring film.

The driver IC generates a control signal and a drive signal for operating the driving piezoelectric elements 21. The driver IC generates a control signal for controlling the timing of ejecting the ink and the selection of the driving piezoelectric elements 21 for ejecting the ink in accordance with an image signal inputted from the control unit 150 of the inkjet recording apparatus 100. The driver IC generates the drive signal to be output to the driving piezoelectric elements 21 in accordance with the control signal. When the driver IC supplies the drive signal to each driving piezoelectric element 21, the driving piezoelectric element 21 is driven so as to displace the diaphragm 30 and change the volume of the pressure chamber 31. As a result, the ink filled in the pressure chamber 31 causes pressure vibration. The ink is ejected from the nozzle 51 provided in the pressure chamber 31 by the pressure vibration. The inkjet head 1 may realize the gradation expression by changing the amount of ink droplets landing on one pixel. Further, the ink jet head 1 may change the amount of ink droplets landing on one pixel by changing the number of times the ink is ejected.

For example, the driver IC includes a data buffer, a decoder, and a driver. The data buffer stores print data in time series for each of the driving piezoelectric elements 21. The decoder controls the driver for each of the driving piezoelectric elements 21 based on the print data stored in the data buffer. The driver outputs a drive signal for operating each of the driving piezoelectric elements 21 under the control of the decoder. The drive signal is, for example, a voltage applied to each of the driving piezoelectric elements 21.

A printed circuit board is a PWA (Printing Wiring Assembly) on which various electronic components and connectors are mounted. The printed wiring board is connected to the control unit 150 of the inkjet recording apparatus 100.

In the inkjet head 1 configured as described above, the nozzle plate 50, the frame portion 60, the manifold 405, and the diaphragm 30 form an ink flow path having the pressure chambers 31 each communicating with the nozzle 51, the individual flow paths 34, the common flow path 33 communicating with the pressure chambers 31, and the common chamber 32. For example, the common chamber 32 communicates with an ink cartridge, and the ink is supplied to the pressure chambers 31 through the common chamber 32. All of the driving piezoelectric elements 21 are connected to each other by wiring so that a voltage can be applied thereto. In the inkjet head 1, when the control unit 150 applies a driving voltage to the electrodes 221 and 222 by the driver IC, the driving piezoelectric elements 21 to be driven vibrate in the stacking direction, that is, in the thickness direction of the piezoelectric layers 211. That is, the driving piezoelectric element 21 vibrates longitudinally.

Specifically, the control unit 150 applies a driving voltage to the internal electrodes 221 and 222 of the driving piezoelectric element 21 to be driven, thereby selectively driving the driving piezoelectric elements 21 to be driven. Then, the diaphragm 30 is deformed by combining the deformation in the tensile direction and the deformation in the compression direction by each driving piezoelectric element 21 to be driven, and the volume of the corresponding pressure chamber 31 is changed, whereby the liquid is guided from the common chamber 32 and discharged from the nozzle 51.

In the inkjet head 1, the nozzle window portion 52 of the nozzle plate 50 and the flow path window portion 44 of the flow path member 40 are arranged in the stacking direction, so that the observation window 11 that allows the support element 25 to be visually recognized is formed from the ejecting surface side of the inkjet head 1.

An example of a method of manufacturing the inkjet head 1 according to the present embodiment will be described. First, internal electrodes 221 and 222 are formed on a piezoelectric material formed in a sheet shape by a printing process. Then, a plurality of piezoelectric layers 211 each having internal electrodes 221 and 222 are stacked and subjected to a calcination treatment to form a stacked piezoelectric member. Then, the stacked piezoelectric member in which the internal electrodes 221 and 222 are formed in advance is arranged on a base 10. For example, the stacked piezoelectric member including two actuator units 20 may be joined to the base 10 as one body, and then the actuator units 20 are divided into two by grooving or the like. Alternatively, two stacked piezoelectric members each forming one actuator unit 20 may be prepared separately.

Subsequently, external electrodes 224 are formed on each of the divided piezoelectric members by a printing process. Further, a plurality of grooves 23 are simultaneously formed at a predetermined pitch by dicing or the like, thereby forming a plurality of columnar elements to be a plurality of piezoelectric elements 21 and 22 arranged at the same pitch and support elements 25.

Further, polarization processing of the columnar elements is performed, and a wiring board is connected to the external electrode 224 serving as an individual electrode by solder mounting. The driving piezoelectric elements 21 arranged at the same pitch, the non-driving piezoelectric elements 22, and the support elements 25 at both ends are formed.

Then, in the actuator unit 20, a diaphragm 30, a plurality of flow path substrates 401, 402, and 403, and a nozzle plate 50 are stacked with a bonding material therebetween to perform positioning, and a frame portion 60 is disposed on the outer periphery of the actuator unit 20 to join those members. The flow path substrates 401, 402, and 403 may be bonded in advance to form one manifold 405, and then stacked and fixed to the actuator unit 20.

At this time, a nozzle window portion 52 of the nozzle plate 50, a flow path window portion 44 of the flow path member 40 formed by the diaphragm 30 and the manifold 405, are arranged in the stacking direction, and the position of the support element 25 is visually or optically detected from the ejecting surface side through the observation window 11, and the positions of the support element 25 and the observation window 11 are aligned, whereby the actuator unit 20, the diaphragm 30, the manifold 405, and the nozzle plate 50 can be positioned with high accuracy. That is, the nozzle 51, the pressure chamber 31, and the driving piezoelectric element 21 can be disposed so as to face each other at the same position in the column direction, and at the same time, the partition wall portion 42 and the non-driving piezoelectric element 22 can be disposed so as to face each other at the same position.

Hereinafter, an example of the inkjet recording apparatus 100 including the inkjet head 1 will be described with reference to FIG. 4. The inkjet recording apparatus 100 includes a housing 111, a medium feeding unit 112, an image forming unit 113, a medium discharge unit 114, a conveyance device 115, and a control unit 150.

The inkjet recording apparatus 100 is a liquid ejecting apparatus that performs an image forming process on a sheet P as a printing medium by ejecting a liquid such as ink while, for example, conveying the sheet P to be conveyed along a predetermined conveyance path A from the medium feeding unit 112 to the medium ejecting unit 114 through the image forming unit 113.

The housing 111 constitutes an outer shell of the inkjet recording apparatus 100. A discharge port for discharging the sheet P to the outside is provided at a predetermined position of the housing 111.

The medium feeding unit 112 includes a plurality of sheet feeding cassettes, and is capable of stacking and holding a plurality of sheets P of various sizes.

The medium discharge unit 114 includes a sheet discharge tray capable of holding the sheet P discharged from the discharge port.

The image forming unit 113 includes a support portion 117 that supports the sheet P, and a plurality of head units 130 that are disposed to face each other above the support unit 117.

The support portion 117 includes a conveyance belt 118 provided in a loop shape in a predetermined region for forming an image, a support plate 119 for supporting the conveyance belt 118 from the back side, and a plurality of belt rollers 120 provided on the back side of the conveyance belt 118.

At the time of image formation, the support portion 117 supports the sheet P on the holding surface, which is the upper surface of the conveyance belt 118, and conveys the sheet P to the downstream side by rotating the conveyance belt 118 at a predetermined timing by the belt roller 120.

The head unit 130 includes a plurality of inkjet heads 1 for four colors, an ink tank 132 as a liquid tank mounted on each of the inkjet heads 1, a connection flow path 133 that connects the inkjet head 1 and the ink tank 132, and a supply pump 134.

In the present embodiment, the inkjet head 1 includes four colors of cyan, magenta, yellow, and black, and the ink tank 132 that accommodates the inks of the colors. The ink tank 132 is connected to the inkjet head 1 by the connection flow path 133.

Further, a negative pressure control device such as a pump (not shown) is connected to the ink tank 132. The ink supplied to the nozzles 51 of the inkjet head 1 is formed in a meniscus having a predetermined shape by controlling the negative pressure in the ink tank 132 by a negative pressure control device in accordance with the head value between the inkjet head 1 and the ink tank 132.

The supply pump 134 is, for example, a liquid supply pump such as a piezoelectric pump. The supply pump 134 is provided in the supply flow path. The supply pump 134 is connected to a drive circuitry of the control unit 150 by a wire, and is controllable by a processor such as a CPU (Central Processing Unit). The supply pump 134 supplies liquid to the inkjet head 1.

The conveyance device 115 conveys the sheet P along the conveyance path A from the medium feeding unit 112 to the medium discharge unit 114 through the image forming unit 113. The conveyance device 115 includes a plurality of guide plate pairs 121 arranged along the conveyance path A, and a plurality of conveyance rollers 122.

Each of the guide plate pairs 121 includes a pair of plate members opposed to each other across the conveyed sheet P, and guides the sheet P along the conveyance path A.

The conveyance roller 122 is driven and rotated under the control of the control unit 150 to feed the sheet P to the downstream side along the conveyance path A. In the conveyance path A, one or more sensors for detecting the conveyance state of the sheet are arranged at various places.

The control unit 150 includes a control circuit or controller including a processor such as a CPU, a ROM (Read Only Memory) that stores various programs, and the like, a RAM (Random Access Memory) that temporarily stores various variable data, image data, and the like, and a network interface circuit that receives data from another device and outputs data to the device.

In the inkjet recording apparatus 100 configured as described above, the control unit 150 drives the inkjet head 1 by, for example, driving the conveyance device 115 to convey the sheet P and outputting a print signal to the head unit 130 at a predetermined timing when a print instruction is input by the user via the operation input unit. As an ejection operation, the inkjet head 1 sends a drive signal to the driver IC according to an image signal corresponding to the image data, applies a drive voltage to the internal electrodes 221 and 222 to selectively drive the driving piezoelectric elements 21 to be driven to longitudinally vibrate in the stacking direction, and changes the volume of the pressure chambers 31 to eject ink from the nozzles 51, thereby forming an image on the sheet P held on the conveyance belt 118. In addition, as the liquid ejecting operation, the control unit 150 drives the supply pump 134 to supply ink from the ink tank 132 to the common chamber 32 of the inkjet head 1.

Here, an operation of driving the inkjet head 1 will be described. The inkjet head 1 according to the present embodiment includes a driving piezoelectric element 21 disposed opposite to each pressure chamber 31, and these driving piezoelectric elements 21 are connected to each other by wiring so that a voltage can be applied thereto. The control unit 150 transmits a drive signal to the driver IC according to an image signal corresponding to the image data, applies a drive voltage to the internal electrodes 221 and 222 of the driving piezoelectric elements 21 to be driven, and selectively deforms the driving piezoelectric elements 21 to be driven. Then, the liquid is discharged by changing the volume of the pressure chamber 31 by combining the deformation of the diaphragm 30 in the tensile direction and the deformation of the compression direction.

For example, the control unit 150 alternately performs a pulling operation and a compressing operation. In the inkjet head 1, when the internal volume of the target pressure chamber 31 is increased, the driving piezoelectric element 21 to be driven is contracted, and the driving piezoelectric element 21 not to be driven is not deformed. In addition, when the internal volume of the target pressure chamber 31 is reduced in the inkjet head 1, the target driving piezoelectric element 21 is extended. The non-driving piezoelectric element 22 and the support element 25 are not deformed.

According to the inkjet head 1 and the inkjet recording apparatus 100 according to the above-described embodiment, the support elements 25 are arranged at the same pitch as the driving piezoelectric elements 21 and the non-driving piezoelectric elements 22, and the observation window 11 is formed by the flow path window portion 44 and the nozzle window portion 52 at the position corresponding to the support element 25. As a result, the support element can be visually and optically detected through the observation window 11. Further, the position of the support element 25 and the observation window 11 can be aligned, and the flow path member 40 and the actuator unit 20 can be arranged at a position where the pressure chambers 31 and the driving piezoelectric elements 21 are aligned, respectively. Further, by continuously processing the piezoelectric elements 21 and 22 and the support element 25 at the same pitch, processing can be performed with high processing accuracy.

Since several hundred or more pressure chambers and piezoelectric elements are simultaneously bonded in a general manufacturing process of a liquid ejection head, when the number of pressure chambers and piezoelectric elements is large and the piezoelectric elements are long, the alignment of those elements is particularly difficult. For example, the pitch of the piezoelectric elements is related to the resolution of the inkjet head, and when the printing is performed at a 600 dpi or higher, for example, the pitch of the piezoelectric elements 21 and 22 is equal to or higher than 300 dpi. In other words, when the driving piezoelectric elements 21 and 22 and the support element 25 supports 600 dpi printing, the elements 21 and 22 are arranged at a pitch of about 85 μm or less. In addition, when a deep groove is formed in the piezoelectric member, since the width of the groove is required to be about 30 μm, the width of each piezoelectric element needs to be 55 μm or less, and thus the pitch becomes narrow and the elements are difficult to align. On the other hand, according to the above-described embodiment, by detecting the positions of the support elements 25 at both ends through the observation window 11 at both ends, the driving piezoelectric elements 21 arranged between the support elements 25 at both ends and the pressure chambers 31 arranged between the observation windows 11 at both ends can be positioned indirectly, so that the alignment accuracy can be easily improved. Further, since the observation window 11 can be visually or optically detected even after bonding, it is possible to confirm that there is no positional deviation after bonding.

Further, in the above embodiment, when the manifold 405 has a stacked structure, since the opening constituting the observation window 11 is formed in each of the flow path substrates 401, 402, and 403, it is easy to secure the positional accuracy of the flow path substrates 401, 402, and 403 in the assembly of the manifold 405.

The configuration of the piezoelectric elements 21 and 22 and the configuration and positional relationship of various components including the flow path member 40, the nozzle plate 50, and the frame portion 60 are not limited to the above-described examples, and can be changed as appropriate. For example, the configuration of the manifold 405 is not limited to the above. For example, three flow path substrates 401, 402, and 403 are formed in the above example, only one member may be formed, or two or four or more substrates may be stacked. Further, the shape of the opening in each of the flow path substrates 401, 402, and 403 is not limited to the above-described example, and can be changed as appropriate.

Further, in the above example, the piezoelectric elements 21 are formed by stacking a plurality of piezoelectric layers and driven by longitudinal vibrations (d33) in the stacking direction, but embodiments are not limited thereto. For example, the piezoelectric elements 21 can be formed of a single-layer piezoelectric member, and can be driven by lateral oscillation (d31).

The arrangement of the nozzles 51 and the pressure chambers 31 is not limited to the above-described example. For example, two or more rows of nozzles 51 may be arranged. Further, an air chamber serving as a dummy chamber may be formed between the pressure chambers 31.

Further, although the piezoelectric elements 21 and 22 have the dummy layer 212 at both ends in the stacking direction in the above-described example, embodiments are not limited thereto. For example, the piezoelectric elements 21 and 22 can have a single dummy layer 212 only on one side, or have no dummy layer 212 at all.

The support elements 25 in the above example are provided at both ends of the two rows, but embodiments are not limited thereto. For example, in a configuration in which two or more rows of the nozzles 51 and the pressure chambers 31 are arranged, for example, the support elements and the observation windows 11 may be arranged at two diagonal positions, e.g., at one end of a first row and the other end of a second row.

Further, for example, a plurality of support elements may be formed at one end portion. In this case, since the observation window 11 is formed so as to face any of the support elements 25, optical position detection can be performed by the observation window 11.

In addition, the nozzle window portion 52 of the nozzle plate 50 may have a light transmitting portion that transmits light instead of an opening such as a through hole. Further, the nozzle window portion 52 may have a shape different from that of the flow path window portion 44. For example, in a case where the nozzle plate 50 is made of a resin film such as polyimide and is translucent, the entire nozzle plate 50 may constitute a light transmitting portion that transmits light. In this case, the portion of the nozzle plate 50 that is aligned with the support element 25 and the flow path window portion 44 becomes the nozzle window portion 52 that constitutes the observation window 11. Also in this case, the support element 25 can be visually and optically detected from the ejecting surface side of the nozzle plate 50 through the nozzle window portion 52 and the flow path window portion 44 of the flow path member 40.

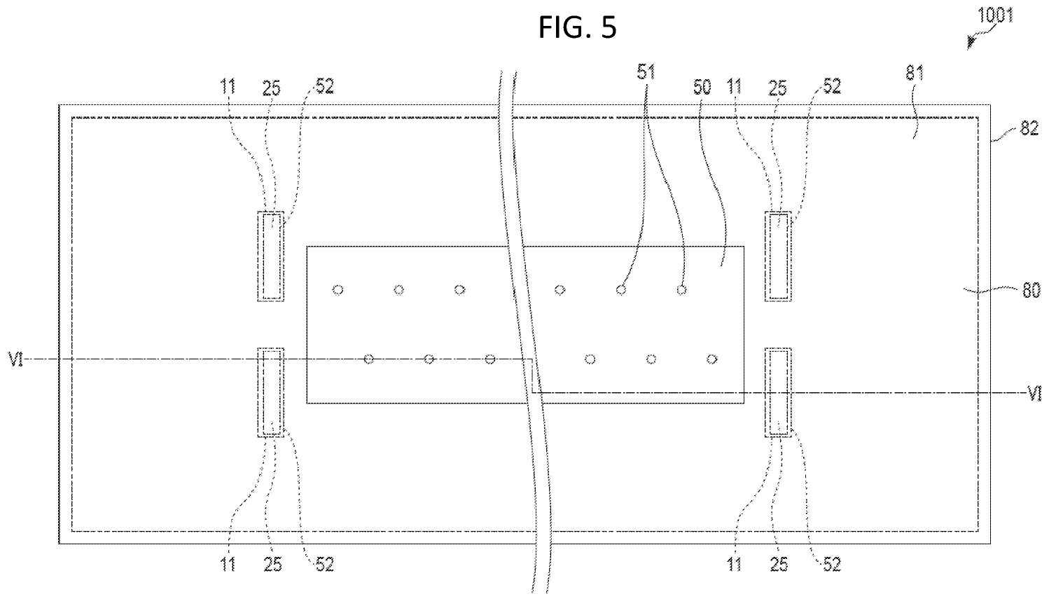

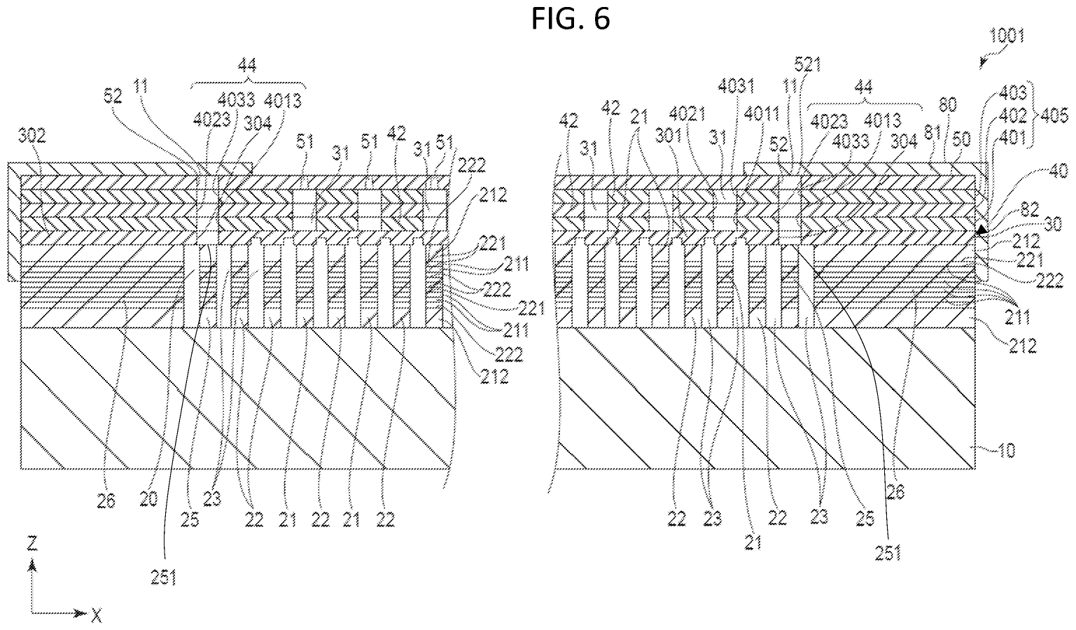

In addition, as in a liquid ejecting head 1001 shown in FIGS. 5 and 6 as another embodiment, a mask plate 80 as a mask member covering the observation window 11 on the outer surface of the front side of the nozzle plate 50 may be further provided. In the liquid ejecting head 1001, the nozzle window portion 52 of the nozzle plate 50 has an opening 521, and the mask plate 80 is provided on the ejecting surface of the nozzle plate 50. The mask plate 80 is formed of, for example, a resin film or a metal foil, and integrally includes a frame-shaped cover portion 81 that covers an outer peripheral portion of a region where the nozzles 51 of the nozzle plate 50 are formed, and a side wall portion 82 that is bent from the cover portion 81 and extends to cover the outer peripheral edge of the nozzle plate 50 and the outer peripheral surface of the manifold 405.

According to the present embodiment, for example, it is possible to prevent ink from entering through the opening 521 of the nozzle window portion 52. Therefore, for example, when the ink is conductive, it is possible to avoid the occurrence of a short circuit caused by the intrusion of the ink into the liquid ejection head.

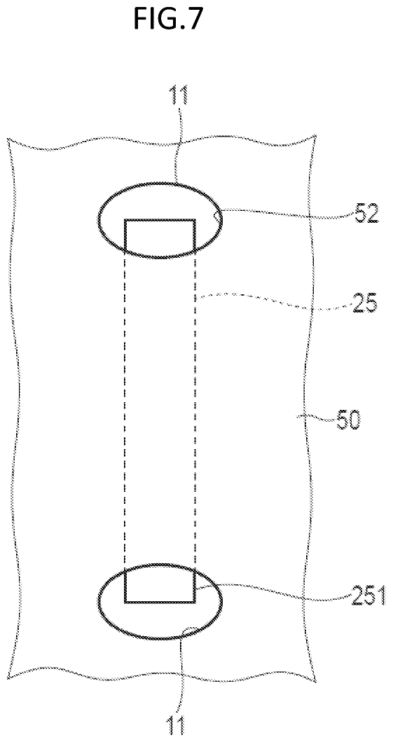

Further, the observation window 11 may be opposed to at least a part of the edge 251 of the end face of the support element 25, and a plurality of observation windows 11 may be provided for one support element 25. For example, as shown in FIG. 7 as another embodiment, a configuration may be adopted in which two of the four corners of the end face of the support element 25 are respectively arranged with respect to one of the support elements 25, and the two observation windows 11 are arranged. Alternatively, for example, the observation window 11 may be provided at at least two points at diagonal positions of four corners of the end face of the support element 25. In these cases, since the individual observation windows 11 can be small, it is possible to secure the rigidity of the member by suppressing the size of the opening constituting the observation window 11. Since the diaphragm 30 closest to the support element 25 is very thin as compared with the other flow path substrates 401, 402, and 403, and is often 10 μm or less in thickness, for example, it becomes difficult to secure the rigidity when the opening becomes large. By configuring the observation window 11 with a small opening as described above, it is possible to detect the edge while securing the rigidity. Note that all of the members arranged in the stacking direction may be divided into a plurality of openings in the same manner, or the openings may be made smaller than other members, for example, only a part of the members of which the rigidity is difficult to secure, for example, the diaphragm 30.

Further, the liquid to be ejected is not limited to the ink for printing, and may be, for example, a liquid containing conductive particles for forming a wiring pattern of a printed wiring board.

Further, in the above examples, the ink jet head 1 is used in the ink jet recording apparatus 100, but embodiments are not limited thereto. The ink jet head 1 can be used in, for example, 3D printers, industrial manufacturing machines, or devices for medical applications, and can be reduced in size, weight, and cost.

According to at least one embodiment described above, a desired flow path shape can be easily set.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A liquid ejection head for ejecting a liquid, comprising:
a base plate extending along a first direction;
an actuator unit on the base plate and including a plurality of first piezoelectric elements and one or more support elements arranged along the first direction;
a flow path member on the actuator unit and including: a plurality of pressure chambers each for storing the liquid and having volumes that can be changed by a corresponding one of the first piezoelectric elements, and one or more first openings at positions corresponding to the support elements; and
a nozzle plate on the flow path member and including: a plurality of nozzles through which the liquid in the corresponding pressure chambers are ejected in response to a change in the volume of the corresponding pressure chambers, and one or more second openings connected respectively to the one or more first openings and through which the support elements corresponding to the one or more first openings are visible.

2. The liquid ejection head according to claim 1, wherein
the actuator unit further includes a plurality of second piezoelectric elements, and
the first and second piezoelectric elements are alternately arranged along the first direction such that each of the first piezoelectric elements is positioned corresponding to one of the pressure chambers.

3. The liquid ejection head according to claim 2, wherein the one or more support elements are positioned next to the second piezoelectric elements that are located at ends of the plurality of second piezoelectric elements in the first direction.

4. The liquid ejection head according to claim 3, wherein the flow path member further includes a diaphragm and one or more flow path substrates stacked on the actuator unit and having openings that make up the first openings.

5. The liquid ejection head according to claim 1, wherein
the first piezoelectric elements are arranged in two rows including first and second rows, and
the one or more support elements are disposed next to the first piezoelectric element located at a first end of the first row and the first piezoelectric element located at a second end of the second row that is diagonal with respect to the first end.

6. The liquid ejection head according to claim 1, further comprising:
a mask plate on the nozzle plate and covering the second openings and a side surface of each of the flow path member and the nozzle plate.

7. The liquid ejection head according to claim 1, wherein the first and second openings are positioned such that at least edges of the corresponding support elements are visible.

8. A liquid ejection head for ejecting a liquid, comprising:
a base plate extending along a first direction;
an actuator unit on the base plate and including a plurality of first piezoelectric elements and one or more support elements arranged along the first direction;
a flow path member on the actuator unit and including: a plurality of pressure chambers each for storing the liquid and having volumes that can be changed by a corresponding one of the first piezoelectric elements, and one or more first openings at positions corresponding to the support elements; and
a nozzle plate on the flow path member and including: a plurality of nozzles through which the liquid in the corresponding pressure chambers are ejected in response to a change in the volume of the corresponding pressure chambers, wherein
the nozzle plate is made of a material that transmits light such that the support elements corresponding to the one or more first openings are visible.

9. The liquid ejection head according to claim 8, wherein
the actuator unit further includes a plurality of second piezoelectric elements, and
the first and second piezoelectric elements are alternately arranged along the first direction such that each of the first piezoelectric elements is positioned corresponding to one of the pressure chambers.

10. The liquid ejection head according to claim 9, wherein the one or more support elements are positioned next to the second piezoelectric elements that are located at ends of the plurality of second piezoelectric elements in the first direction.

11. The liquid ejection head according to claim 10, wherein the flow path member further includes a diaphragm and one or more flow path substrates stacked on the actuator unit and having openings that make up the first openings.

12. The liquid ejection head according to claim 8, wherein
the first piezoelectric elements are arranged in two rows including first and second rows, and
the one or more support elements are disposed next to the first piezoelectric element located at a first end of the first row and the first piezoelectric element located at a second end of the second row that is diagonal with respect to the first end.

13. The liquid ejection head according to claim 8, wherein the first openings are positioned such that at least edges of the corresponding support elements are visible.

14. An inkjet recording apparatus, comprising:
a conveyance device configured convey a medium;
a conveyance belt along which the medium is conveyed; and
an inkjet head facing the conveyance belt and including:
a base plate extending along a first direction,
an actuator unit on the base plate and including a plurality of first piezoelectric elements and one or more support elements arranged along the first direction,
a flow path member on the actuator unit and including: a plurality of pressure chambers each for storing ink and having volumes that can be changed by a corresponding one of the first piezoelectric elements, and one or more first openings at positions corresponding to the support elements, and
a nozzle plate on the flow path member and including: a plurality of nozzles through which the ink in the corresponding pressure chambers are ejected in response to a change in the volume of the corresponding pressure chambers, and one or more second openings connected respectively to the one or more first openings and through which the support elements corresponding to the one or more first openings are visible.

15. The inkjet recording apparatus according to claim 14, wherein
the actuator unit further includes a plurality of second piezoelectric elements, and
the first and second piezoelectric elements are alternately arranged along the first direction such that each of the first piezoelectric elements are positioned corresponding to one of the pressure chambers.

16. The inkjet recording apparatus according to claim 15, wherein the one or more support elements are positioned next to the second piezoelectric elements that are located at ends of the plurality of second piezoelectric elements in the first direction.

17. The inkjet recording apparatus according to claim 16, wherein the flow path member further includes a diaphragm and one or more flow path substrates stacked on the actuator unit and having openings that make up the first openings.

18. The inkjet recording apparatus according to claim 14, wherein
the first piezoelectric elements are arranged in two rows including first and second rows, and
the one or more support elements are disposed next to the first piezoelectric element located at a first end of the first row and the first piezoelectric element located at a second end of the second row that is diagonal with respect to the first end.

19. The inkjet recording apparatus according to claim 14, wherein the inkjet head further includes a mask plate on the nozzle plate and covering the second openings and a side surface of each of the flow path member and the nozzle plate.

20. The inkjet recording apparatus according to claim 14, wherein the first and second openings are positioned such that at least edges of the corresponding support elements are visible.
